(19) United States
(12) Patent Application Publication
(10) Pub. No.: US 2021/0244036 A1
(43) Pub. Date: Aug. 12, 2021

(54) Kake Kutters

(71) Applicant: Egyptian Zanobian Krystal-Tee Turner, Waco, TX (US)

(72) Inventor: Egyptian Zanobian Krystal-Tee Turner, Waco, TX (US)

(21) Appl. No.: 16/788,435

(22) Filed: Feb. 12, 2020

(51) Int. Cl. A21C 11/10

(52) U.S. Cl. CPC A21C 11/106

(57) ABSTRACT

Kake Kutters are a complete set of box or circular alphabetic letters (A-Z), numeric num- bets (0-9) and a plurality of themed shapes. They have cutter bodies, made with parallel raised side walls fixed in shape, no bottom or top surface, hollow in the center and able to cut through cakes and pastries. When the Kake Kutter is pressed down into a baked cake or pastry, uniformed shapes and letters in alphanumeric configurations are formed hereto- fore unachievable, and gives the user the ability to quickly, precisely and uniformly stamp out personalized custom-made cakes or pastries themed for any occasion, ranging from simple to ornate.

### BACKGROUND OF THE INVENTION

On special occasions, such as birthdays, anniversaries, graduations, welcome home or retirement parties, people are usually presented with a cake that forms the basis of which the whole event centers on

For example, on a daughter's 25th birthday, the number 2 and number 5 candle figures are placed on top of the cake. Just as on a golden wedding anniversary, the numeral 50 in candle figures are added on top of a cake.

With the alphanumeric and shape Kake Kutters a person is especially fortunate, the cake itself is made into the shape of numbers, letters or shapes having a long-remembered significance. That is to say, the cake itself is shaped so as to form the numbers 2 and 5 or the number 50; or can be formed in the person's initials, nickname or shaped in a heart or a decorative ornament on special occasions.

Alphanumeric & shape Kake Kutters give you the ability to quickly uniformly, and precisely stamp out custom-made or celebratory cakes themed for any occasion from simple to ornate. Forming cakes into uniform, personalized shapes containing words, initials, or dates for different occasions would be a whole lot harder and time consuming without Kake Kutters. Being a baker I realized that the invention is so simple and obvious that no one has thought to create them.

Despite the fact that everyone enjoys these unique delicacies, it is rare that anyone other than a baker can provide the skill necessary to prepare cakes having alphanumeric or shape configurations. Thus, as a result of the time and cost involved to prepare them, the use of such cakes is restricted to some extent, to fewer occasions that could he realized,

### Summary of the Invention

By the present invention, specialized Kate Kutters are disclosed. Accordingly, one of the objects of the present invention is to provide alphanumeric and themed shaped cakes that can be especially arranged for use even by inexperienced people to enable them economically to prepare cakes possessing any desired plurality of letters, initials, numbers or shapes that hold a personalized significance.

These are Kake Kutters that are made of letters, numbers, and shape cutter bodies having vertical side walls with hollow centers to cut cakes that form meaningful names, initials, or dates for a plurality of occasions. Before you began, sprinkle flour or sugar on the Kake Kutter to keep the cake from sticking. After the cake has been baked and cooled out of the pan, the alphanumeric or shaped Kake Kutter is gently pressed down into the cake relative to the cake boundary walls maintaining an accurate alignment until it reaches the bottom precisely configuring the shape of the Kake Kutter, then the remaining cake is separated and removed. This same process can be duplicated in order to create a double layered or triple layered cake if so desired. The custom-made shaped cake can then be covered with frosting/icing/fondant or not, or otherwise decorated as desired, in order to make it ready for presentation. No cake is wasted; the remaining cake is separated and. could be used for other sweet delicious delicacies such as cake pops, cake balls, jar cakes or cake parfaits.

### Disclosure Of The Invention

With my present invention of Kake Kutters cakes can be spelled with individual letters, numbers, and themed shapes that will be able to convey messages, or have special mean- ings. In today's growing demand for personalized cakes a great deal of significance is placed on words, names, initials, occasions, important ages and dates, marked anniver- saries or birthdates, with that being said; infinite variations may be formed by having a set of alphanumerical or shape cakes that are easily able to form words, initials, or important dates. It is, therefore, the primary object of my instant invention to fill a need previously not realized, allowing cakes to be unitized with combinations of letters, numbers and themed shapes that create an entirely novel pattern that can easily be changed into words or dates having significance to the person intended.

An important object of the invention allows the use of the Kake Kutters to form words from edible material that has structural integrity.

Another object of the invention is that Kake Kutters form cakes that have themed shapes that are representational of occasions or holiday seasons, and are used to allow words to be used that are personally directed to the circumstance or situation in a serious or even a humorous manner furthering the utility of the invention.

### Prior Art

Previously, cake cutters collectively have been in most cases associated with have cutting blades and edges cutting cakes into segments or slices. While the shape of a cutter is not unique by itself, but a combination of individual cakes side by side to form a recognizable word, initials or shapes offers a cake made therefrom novelty not heretofore achieved. A search of the prior art failed to disclose any cake cutters that read on the claims of my instant invention, however, for background purposes and as indicative of the art to which. this invention relates, the following patents are cited. Saleeba, in U.S. Pat. No. 4,452,419, discloses a design using modular cake pans with a horizontal bottom and peripheral upstanding side walls temporarily receiving one or more cake-shaping modular inserts while a cake is being baked, or otherwise fixed in shape. A matrix, or gridwork, delineated on the bottom of the receptacle is matched to the size and shape of the modular inserts and provides a guide for the proper positioning of the modular inserts in order to form the cake into selected alphanumeric configurations. The use of modular inserts while a cake is being baked, by its very nature, exclude them from being used to form letters, numerals and shapes for baked cakes. Heron, in U.S. Pat, No. 4,818,207, discloses a design using dough cutters having a plurality of individual raised cursive alphabetic. letters attached together to form a continuous combination of letters comprising, and rectangular cutter bodies each having a top surface, and a bottom surface with the letter starting and ending at the same position on the sides dative to the lower edge. The use of the design would, by its very nature, exclude them from being used to form letters, numerals and shapes for baked cakes. Riddle, in U.S. Pat. No, Des. 161,208, discloses a design using the alphabet in a dish set wherein each dish is formed into the shape of one of the letters of the alphabet. All of the shapes of the dishes are formed from upper case letters and the bottoms are flat with outwardly tapered sides. The use of the design would, by its very nature, exclude them from being used to form letters, numerals and shapes for baked cakes. None of the above noted patents, taken either singly or in combination, are seen to disc close the specific arrangement of concepts disclosed by my present invention.

### BRIEF DESCRIPTION OF DRAWINGS

FIG. 1 is a top perspective view of a particular shape Kake Kutter;

FIG. 2 is the bottom perspective view of a particular shape Kake Kutter as shown in FIG. 1;

FIG. 3 is a side cross-sectional perspective view of a particular shape Kake Kutter as shown in FIG. 1;

FIG. 4 is a top perspective view of a box alphabetic Kake Kutter being utilize to press down into a cake;

FIG. 5 is a top view of the alphabetic cake formed resulting from the use of the Kake Kutter shown in FIG. 4.

FIG. 6 shows the process of using a Kake Kutter from the beginning and ending with the desired alphabetic shape as shown in FIGS. 4 and 5.

### PREFERRED EMBODIMENT OF THE INVENTION

### Best Mode For Carrying Out The Invention

The best mode for carrying out the invention is presented in terms of a preferred, second and third embodiments.

These and other objects and advantages of my present invention will become apparent froze the subsequent detailed description of the preferred embodiment and the appended claims taken in conjunction with the accompanying drawings.

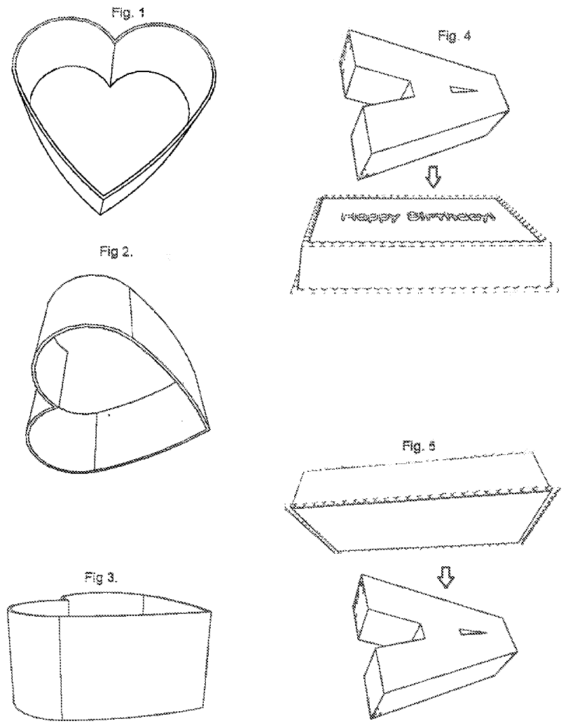

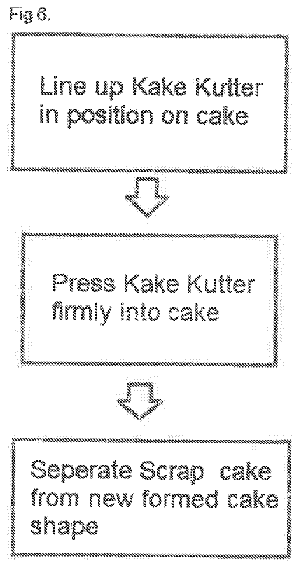

The preferred embodiment, is the ability to mass produce the Kake Kutters shown in FIGS. 1 through 4 made of circular and box cutter bodies, in a cost effective manner. Once the cost of the tooling is absorbed (One time tooling fee), the price of mass produced Kake Kutters is reasonable even when the entire alphabet is required, as manufacturing techniques such as hand or hydraulic metal molding, 3D printing, and plastic injection molding is well known in the art and in common usage.

The second embodiment, is usually cakes are limited to one mold per pan for each separate form, on an average week I produce up to 30 to 40 single layered cakes that are used to make double or triple tiers, so to be able to produce the most numbers or letters out of ¼ sheet, ½ sheet or full sheet cakes prove to be more efficient in time, efforts, materials, and method.

The third embodiment of the invention, is that even though Kake Kutters can be made of any material suitable for the application, however, metal, aluminum, tin, stainless steel, and copper would he the most economical route and most preferred. Durable plastic, stainless steel, die cast zinc or ferrous compositions may also be used with equal ease. A. thermoplastic or thermoset plastic would also be suitable. Any number of plastic compositions may be utilized, or the like.

While the invention has been described in complete detail and pictorially shown in the accompanying drawings, it is not to be limited to such details, since many changes and modifications may be in the invention without departing from the spirit and the scope thereof. Hence, it is described to cover any and all modifications and forms which may come within the language and scope of the appended claims.

I claim: The alphanumeric and shape design for a Kake Kutter, as shown and described.

1. Kake Kutters having their own individual alphabetic letters, numbers, and shape cutter bodies are used for forming cakes made of personalized names, initials, and dates for special occasions comprising;
(a) raised side walls made-up of a circular or box frame cutter body each having a smooth upper edge, a lower cutting edge, a first and second side, and a hollow center forming a letter mold;
(b) raised side walls made-up of a circular or box frame cutter body each having a smooth upper edge, a lower cutting edge, a first and second side, and a hollow center forming a number mold;
(c) raised side walls made-up of a plurality of different themed shape frame cutter bodies each having a smooth upper edge, a lower cutting edge, a first and second side and a hollow center forming a shape mold;

2. Kake Kutters are for forming baked cakes or pastries in the shape of circular letters, numbers or themed shapes.

3. Kake Kutters are for forming baked cakes or pastries in the shape of box letters, numbers or themed shapes.

4. Kake Kutters are available in three alphanumeric sizes (1) 9 in tall-Depth 3 in used for quarter sheet cakes (2) 12 inches tall-Depth 3 inches used for half sheet cakes and (3) 18 inches tall-Depth 3 inches used for full sheet cakes.

5. The Kake Kutters as recited in claims 2 and 3 said of circular or box cutter bodies comprise; metallic material able to resist cutting pressure.

6. The Kake Kutters as recited in claims 2 and 3 said of circular or box cutter bodies further comprise; tin material able to resist cutting pressure.

7. The Kake Kutters as recited in claims 2 and 3 said of circular or box cutter bodies further comprise; aluminum material able to resist cutting pressure.

8. The Kake Kutters as recited in claims 2 and 3 said of circular or box cutter bodies further comprise; stainless steel material able to resist cutting pressure.

9. The Kake Kutters as recited in claims 2 and 3 said of circular or box cutter bodies further comprise; copper material able to resist cutting pressure.

10. The Kake Kutters as recited in claims 2 and 3 said of circular or box cutter bodies further comprise; durable plastic material able to resist cutting pressure.

11. The Kake Kutters as recited in claims 2 and 3 said of circular or box cutter bodies further comprise; durable thermoplastic material able to resist cutting pressure.
